(19) United States
(12) Patent Application Publication
(10) Pub. No.: US 2008/0153631 A1
(43) Pub. Date: Jun. 26, 2008

(54) Combination golf ball gauge and divot repair device and method

(76) Inventor: Robert J. Mazetta, Henderson, NV (US)

Correspondence Address: WEISS & MOY PC, 4204 NORTH BROWN AVENUE, SCOTTSDALE, AZ, 85251, US

(21) Appl. No.: 11/645,201

(22) Filed: Dec. 26, 2006

(51) Int. Cl. A63B 57/00; G01B 3/00

(52) U.S. Cl. 473/408; 33/501

(57) ABSTRACT

A combination golf ball gauge and divot repair device is disclosed. The device includes a gauge portion and a divot tool portion. The gauge portion of the device may be used to assist a golfer in determining whether a golf ball has become out of round and, thereby, unsuitable for play. The divot tool portion may be used to repair divots left by golf balls on putting greens, in accordance with golf etiquette. The combination of the golf ball gauge portion and divot tool portion may provide for a convenient all-in-one tool for golfers.

### FIELD OF THE INVENTION

This invention relates to devices used for the game of golf and, more particularly, to a device that tests the roundness of a golf ball and which also may be used to repair divots.

### BACKGROUND OF THE INVENTION

Golf balls may become misshaped through repeated use, losing their roundness or becoming “out of round.” Misshaped golf balls may not be desirable or suitable for play because when such golf balls are struck by a golf club, the flight path of the golf balls may be altered, resulting in golf shots that are hooked, sliced, or the like. Detecting whether a golf ball is out of round ball may be difficult with an unaided eye.

Standard golf etiquette requires golfers to repair any divots left by their golf balls on putting greens. Divot tools have been devised for this purpose. Various types of divot tools are known in the prior art, including standard divot tools and divot tools that include additional features, such as ball markers, knives, key chains, etc. However, prior art divot tools do not include golf ball gauges. Given that most golfers carry (or should carry) divot tools when playing a round of golf, and since golfers may desire to ascertain whether the golf balls they use have become out of round, it would be desirable and convenient to have a divot tool combined with golf ball gauge. In this way, golfers would not be required to carry separate tools in order to repair divots and to test the roundness of their golf balls.

A need therefore exists for a golf tool that is capable of testing the roundness of a golf ball and that also may be used to repair divots.

The present invention satisfies these needs and provides other, related advantages.

### SUMMARY OF THE INVENTION

In accordance with an embodiment of the present invention, a combination golf ball gauge and divot repair device is disclosed. The device comprises: a gauge portion comprising substantially a ring having an exterior region and an interior region, wherein a diameter of the interior region corresponds to a diameter of a golf ball to be passed therethrough; and a divot tool portion extending outwardly from the gauge portion, wherein the divot tool portion comprises a plurality of prongs.

In accordance with another embodiment of the present invention, a combination golf ball gauge and divot repair device is disclosed. The device comprises: a gauge portion comprising substantially a ring having an exterior region and an interior region, wherein a diameter of the interior region corresponds to a diameter of a golf ball to be passed therethrough; a divot tool portion extending outwardly from the gauge portion, wherein the divot tool portion comprises a pair of prongs; and an opening situated between the exterior region and the interior region.

In accordance with a further embodiment of the present invention, a method for determining whether a golf ball has become out of round is disclosed. The method comprises the steps of: providing a combination golf ball gauge and divot repair device comprising a gauge portion comprising substantially a ring having an exterior region and an interior region, wherein a diameter of the interior region corresponds to a diameter of a golf ball to be passed therethrough, and a divot tool portion extending outwardly from the gauge portion, wherein the divot tool portion comprises a plurality of prongs; providing a golf ball; positioning the golf ball through the gauge portion of the combination golf ball gauge and divot repair device; rotating the golf ball; observing whether any gaps exist between the golf ball and the gauge portion of the combination golf ball gauge and divot repair device; and observing whether the golf ball fails to rotate through the gauge portion of the combination golf ball gauge and divot repair device.

### BRIEF DESCRIPTION OF THE DRAWINGS

FIG. 1 is a perspective view of a combination golf ball gauge and divot repair device, consistent with an embodiment of the present invention.

FIG. 2 is a front view of the device of FIG. 1.

FIG. 3 is a side view of the device of FIG. 1.

### DETAILED DESCRIPTION OF THE PREFERRED EMBODIMENTS

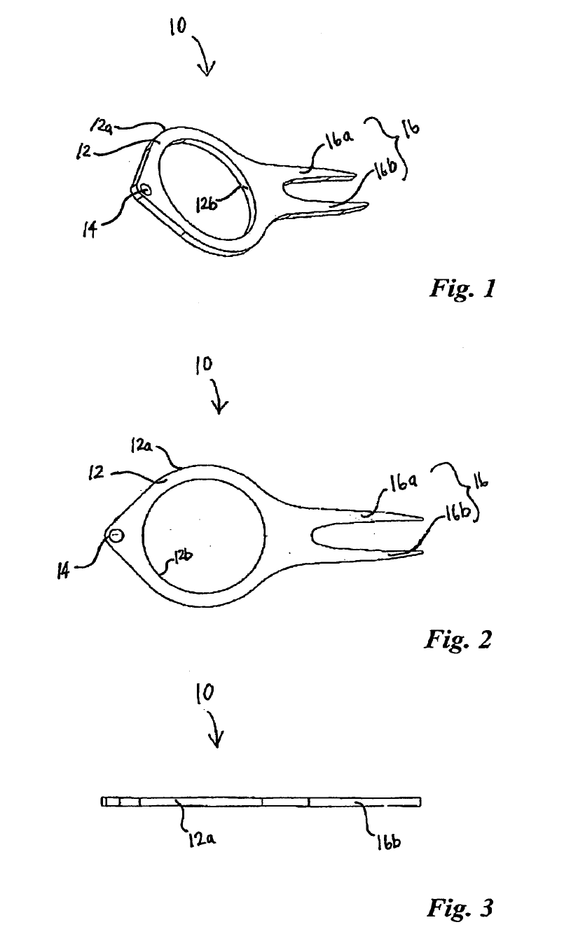

Referring to FIGS. 1-3, a combination golf ball gauge and divot repair device 10 is shown. The combination golf ball gauge and divot repair device 10 preferably comprises a one-piece assembly including the following main components: a gauge portion 12 and a divot tool portion 16.

The gauge portion 12 is preferably substantially ring-shaped, as best seen in FIGS. 1 and 2. The gauge portion 12 comprises an exterior region 12a and an interior region 12b. The interior region 12b, as shown in this embodiment, is circular and is adapted to surround a golf ball. The interior region 12b should have a diameter corresponding to a diameter of a golf ball to be placed therethrough. For example, it may be desirable for the interior region 12b to have a diameter of 1.680 inches or more, in order to correspond to United States Golf Association (“USGA”) compliant golf balls. According to USGA rules, such golf balls must have a minimum diameter of 1.680 inches. It may also be desired for the interior region 12b to have a diameter of 1.685 inches. It may further be desired for the interior region 12b to have various other diameters, in order to correspond to a diameter of a particular golf ball.

The combination golf ball gauge and divot repair device 10 may be used to determine whether a golf ball has become out of round by positioning a golf ball within the gauge portion 12, such that the interior region 12b surrounds the golf ball. The golf ball would then be rotated by a user of the combination golf ball gauge and divot repair device 10. If the interior region 12b becomes obstructed by and cannot pass around the golf ball, or if gaps appear between the golf ball and the interior region 12b as the gauge portion is passed around the golf ball, then it may be determined that the golf ball has become out of round.

In this embodiment, the gauge portion further includes an opening 14. The opening 14 may be used for running a length of chain, such as a beaded chain, key chain, or the like, therethrough. In this way, the combination golf ball gauge and divot repair device 10 may be conveniently attached to and carried with a golf bag, a set of keys, or some other object when the combination golf ball gauge and divot repair device 10 is not in use. The exterior region 12a of the gauge portion 12, as shown in this embodiment, protrudes outward slightly, forming substantially a V-shape, in order to accommodate the opening 14. It may be desired for the opening 14 to be situated relatively in the middle of the combination golf ball gauge and divot repair device 10, in between the gauge portion 12 and divot tool portion 16. It may also be desired to provide a combination golf ball gauge and divot repair device 10 in which the opening 14 is omitted. In the event that the opening 14 is either situated relatively in the middle of the combination golf ball gauge and divot repair device 10 or omitted altogether, it would not be necessary for the exterior region 12a to protrude outward slightly. However, the exterior region 12a may still protrude outward slightly, forming substantially a V-shape, as shown in FIGS. 1 and 2, or some other suitable shape, if desired.

The divot tool portion 16 of the combination golf ball gauge and divot repair device 10 comprises of a pair of prongs 16a and 16b. In this embodiment, the prongs 16a and 16b extend outwardly from the gauge portion 12. While the divot repair tool portion 16 in this embodiment comprises two prongs 16a and 16b, it may be desired to fashion a divot repair tool portion 16 having more than two prongs. The divot tool portion 16 of the combination golf ball gauge and divot repair device 10 may be used to repair a divot on a golf course, in a manner that would ordinarily be used with a standard prior art divot tool.

With respect to materials used for the combination golf ball gauge and divot repair device 10, preferably the combination golf ball gauge and divot repair device 10 is composed of metal, plastic, or some other desired relatively strong material, such that the combination golf ball gauge and divot repair device 10 may be resistant to bending or breaking when the prongs 16a and 16b are inserted into the ground and force is applied to the combination golf ball gauge and divot repair device 10 in order to repair a divot.

While the invention has been particularly shown and described with reference to the preferred embodiments thereof, it will be understood by those skilled in the art that the foregoing and other changes in form and details may be made therein without departing from the spirit and scope of the invention.

I claim:

1. A combination golf ball gauge and divot repair device comprising:
a gauge portion comprising substantially a ring having an exterior region and an interior region, wherein a diameter of the interior region corresponds to a diameter of a golf ball to be passed therethrough; and
a divot tool portion extending outwardly from the gauge portion, wherein the divot tool portion comprises a plurality of prongs.

2. The device of claim 1 wherein the diameter of the interior region is 1.680 inches.

3. The device of claim 1 wherein the diameter of the interior region is 1.685 inches.

4. The device of claim 1 wherein the divot tool portion comprises two prongs.

5. The device of claim 1 further comprising an opening situated between the exterior region and the interior region.

6. The device of claim 5 wherein the opening is positioned at an end of the device that is opposite from the divot tool portion.

7. The device of claim 5 wherein the opening is positioned between the gauge portion and the divot tool portion.

8. A combination golf ball gauge and divot repair device comprising:
a gauge portion comprising substantially a ring having an exterior region and an interior region, wherein a diameter of the interior region corresponds to a diameter of a golf ball to be passed therethrough;
a divot tool portion extending outwardly from the gauge portion, wherein the divot tool portion comprises a pair of prongs; and
an opening situated between the exterior region and the interior region.

9. The device of claim 8 wherein the diameter of the interior region is 1.680 inches.

10. The device of claim 8 wherein the diameter of the interior region is 1.685 inches.

11. A method for determining whether a golf ball has become out of round, comprising the steps of:
providing a combination golf ball gauge and divot repair device comprising:
a gauge portion comprising substantially a ring having an exterior region and an interior region, wherein a diameter of the interior region corresponds to a diameter of a golf ball to be passed therethrough; and
a divot tool portion extending outwardly from the gauge portion, wherein the divot tool portion comprises a plurality of prongs;
providing a golf ball;
positioning the golf ball through the gauge portion of the combination golf ball gauge and divot repair device;
rotating the golf ball;
observing whether any gaps exist between the golf ball and the gauge portion of the combination golf ball gauge and divot repair device; and
observing whether the golf ball fails to rotate through the gauge portion of the combination golf ball gauge and divot repair device.

12. The method of claim 11 wherein the diameter of the interior region is 1.680 inches.

13. The method of claim 11 wherein the diameter of the interior region is 1.685 inches.

14. The method of claim 11 wherein the divot tool portion comprises two prongs.

15. The method of claim 11 further comprising an opening situated between the exterior region and the interior region.

16. The method of claim 15 wherein the opening is positioned at a first end of the device that is opposite from the divot tool portion.

17. The method of claim 15 wherein the opening is positioned between the gauge portion and the divot tool portion.
